(19) United States
(12) Patent Application Publication
(10) Pub. No.: US 2011/0229380 A1
(43) Pub. Date: Sep. 22, 2011

(54) CONTAINER FOR IN VITRO DISSOLUTION RATE TEST OF EFFICIENT COMPONENTS OF PHARMACEUTICAL TOPICAL PATCH

(76) Inventor: HAE-SHANG SHEU, TAINAN CITY (TW)

(21) Appl. No.: 13/040,439

(22) Filed: Mar. 4, 2011

(30) Foreign Application Priority Data
Mar. 22, 2010 (TW) 099204954

(51) Int. Cl. B01L 3/00

(52) U.S. Cl. 422/547

(57) ABSTRACT

A container for an in vitro dissolution test of efficient components of a pharmaceutical topical patch includes a body having an open upper end. A mesh bottom cap is mounted to a bottom of the body. The mesh bottom cap includes a lower mesh. A mesh top cap has an upper mesh covering the upper end of the body. The pharmaceutical topical patch is retained in the body to avoid excessive expansion of the pharmaceutical topical patch due to excessive absorption of the reagent in a vessel, avoiding interference with stirring of a paddle in the vessel and providing accurate test results.

### BACKGROUND OF THE INVENTION

The present invention relates to a container and, more particularly, to a container for an in vitro dissolution rate test of efficient components of a pharmaceutical topical patch.

To obtain information of the quick action and long action of the components of a pharmaceutical topical path, it is important to proceed with dissolution rate tests to simulate dissolution of the components in the skin of a human body. Furthermore, tests on some pharmaceuticals having controlling components for controlling delayed release of efficient components also required for solid pharmaceuticals as a basis for decision on bioavailability and bioequivalent. As an example, if the dissolution rate of a medicament in a test is slow, the medicament is difficult to dissolve in use. The dissolution rate test is, thus, important to the characteristics of the medicaments. Current dissolution rate tests for pharmaceutical topical patches are in vitro and must follow the regulations of USP (United States Pharmacopeia).

With reference to FIG. 1, a vessel 10 is used in a dissolution rate test. A large number of vessels 10 can be used to proceed with a massive test. A reagent 17 simulating human body tissue is filled into each vessel 10 and stirred by a paddle 11 to stimulate dissolution in the human body tissue. A disk assembly 12A in the form of a glass pane is received in the vessel 10 at a location adjacent to a bottom of the vessel 10. A pharmaceutical topical patch 13 to be tested is mounted to a side of the disk assembly 12A and covered by a net 14. The meshes of the net 14 allow the pharmaceutical topical patch 13 to contact with and dissolve into the reagent 17. To retain the pharmaceutical topical patch 13 in place, holders 15 are provided to an outer periphery of the disk assembly 12A to hold the net 14, the pharmaceutical topical patch 13, and the disk assembly 12A in the overlapped state.

However, the disk assembly 12A has a considerable cross sectional area and, thus, is liable to droop when it is held in the vessel 10 having a doomed bottom, resulting in a large dead volume 16 in the bottom of the vessel 10 away from the area that can be stirred by the paddle 11. Thus, the dissolution concentration in the dead volume 16 is higher than that in the upper portion of the reagent 17 above the disk assembly 12A, leading to an inaccurate dissolution rate test and to adverse affect to accuracy of use of the pharmaceutical topical patch 13 on a real human skin. Furthermore, use of the holders 15 is troublesome and inconvenient. Further, the bottom of the glass pane is closed, providing poor contact between the pharmaceutical topical patch 13 and the reagent 17.

With reference to FIGS. 2 and 2A, to avoid the disadvantages of large cross sectional area of the disk assembly 12A and of the large dead volume 16, a disk assembly 12B has been proposed and includes an annular member 121 having a longitudinal through-hole. A net 122 is mounted to a bottom side of the annular member 121. A pharmaceutical topical patch 13 is mounted on a side of the net 122. However, the pharmaceutical topical patch 13 is liable to absorb excessive reagent 17 in the vessel 10, because the annular member 121 has an opening in the upper end thereof. The pharmaceutical topical patch 13 can expand to an extent interfering with stirring of the paddle 11. Furthermore, the dissolution area of the pharmaceutical topical patch 13 changes during stirring. Further, the flow of the reagent 17 in the vessel 10 and the concentration of the dissolved efficient components in the vessel 10 are adversely affected. The accuracy of the dissolution rate test is, thus, adversely affected.

### BRIEF SUMMARY OF THE INVENTION

A container for an in vitro dissolution rate test of efficient components of a pharmaceutical topical patch according to the present invention includes a body having an open upper end. A mesh bottom cap is mounted to a bottom of the body. The mesh bottom cap includes a lower mesh. A mesh top cap has an upper mesh covering the upper end of the body.

Preferably, the body includes a ring having a longitudinal hole. The mesh bottom cap includes an annular member defining a through-hole. A ledge extends radially inward from an inner periphery of the through-hole along a bottom side of the annular member facing away from the ring. The lower mesh abuts the ledge. An inner periphery of the annular member is in tight coupling with an outer periphery of the ring through material resiliency.

Preferably, the mesh top cap includes an annular member defining a through-hole. A ledge extends radially inward from an inner periphery of the through-hole along a top side of the annular member facing away from the ring. The upper mesh abuts the ledge. An inner periphery of the annular member is in tight coupling with the outer periphery of the ring through material resiliency.

During the dissolution rate test, the pharmaceutical topical patch is received in the container according to the present invention and retained in the body. The container is placed in a vessel receiving a reagent. The cross sectional area of the container corresponds to that of the vessel to avoid excessive dead volume. Due to provision of the mesh bottom cap mounted to the bottom of the body, the pharmaceutical topical patch can be in sufficient contact with the reagent in the vessel. Due to provision of the mesh top cap on the upper end of the body, the pharmaceutical topical patch is securely retained in the body. The open upper end of the body is fixed and has a known, fixed area, avoiding excessive expansion of the pharmaceutical topical patch due to excessive absorption of the reagent and avoiding interference with stirring of a paddle in the vessel. The flow of reagent in the vessel and uniform concentration in the reagent are assured, providing accurate test results.

The present invention will become clearer in light of the following detailed description of illustrative embodiments of this invention described in connection with the drawings.

### DESCRIPTION OF THE DRAWINGS

FIG. 1 shows a schematic cross sectional view of a conventional device for carrying out a dissolution rate test of efficient components of a pharmaceutical topical patch.

FIG. 2 shows a schematic cross sectional view of another conventional device for carrying out a dissolution rate test of efficient components of a pharmaceutical topical patch.

FIG. 2A is an enlarged view of a circled portion of FIG. 2.

FIG. 3 shows an exploded, perspective view of a container for an in vitro dissolution rate test of efficient components of a pharmaceutical topical patch according to the present invention.

FIG. 4 shows a device for carrying out for an in vitro dissolution rate test of efficient components of a pharmaceutical topical patch using the container according to the present invention.

FIG. 4A shows an enlarged view of a circled portion of FIG. 4.

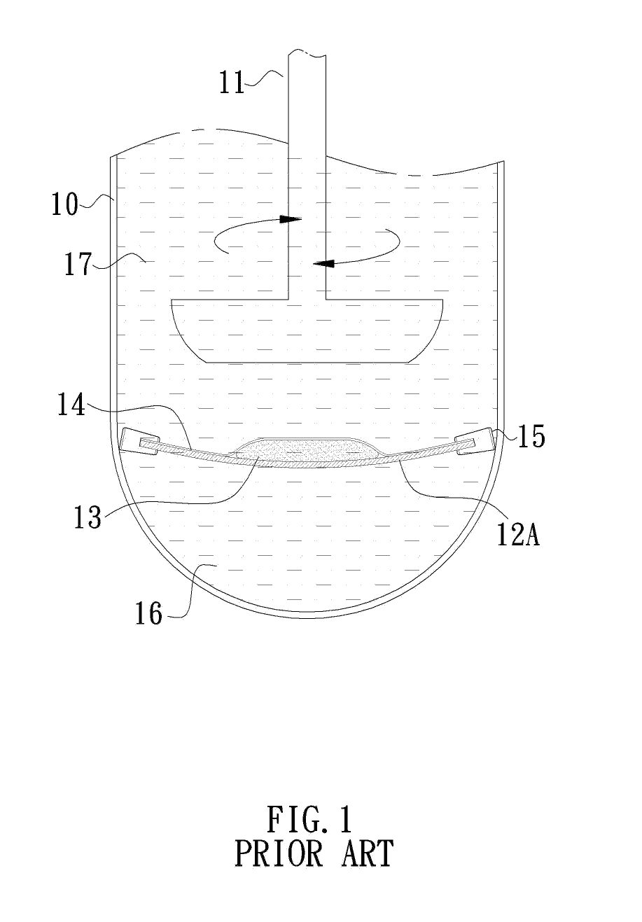

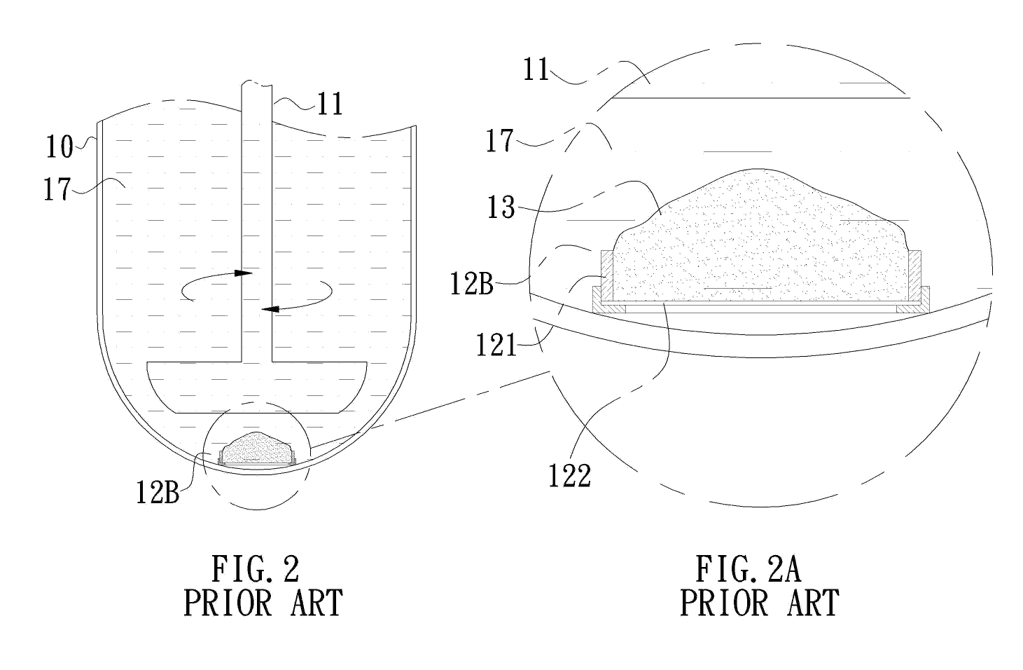

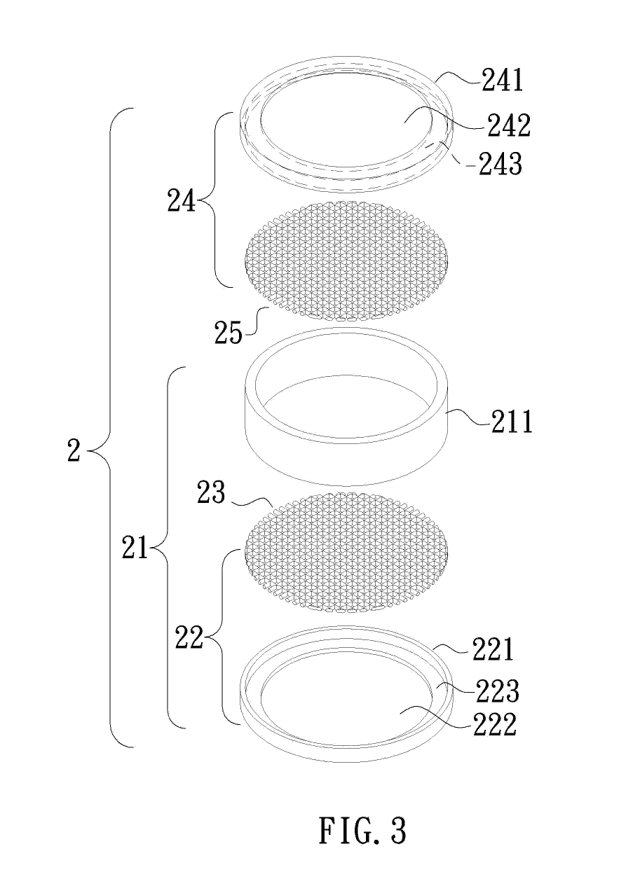

### DETAILED DESCRIPTION OF THE INVENTION

With reference to FIG, 3, a container 2 for an in vitro dissolution rate test of efficient components of a pharmaceutical topical patch according to the present invention includes a body 21 having an open upper end. A mesh bottom cap 22 is mounted to a bottom of the body 21. The mesh bottom cap 22 includes at least a lower mesh 23. It can be appreciated that the mesh bottom cap 22 can include the lower mesh 23 only.

The container 2 further includes a mesh top cap 24 having at least an upper mesh 25. It can be appreciated the mesh top cap 24 can include the upper mesh 25 only. The upper mesh 25 covers the upper end of the body 21.

In the illustrated embodiment, the body 21 includes a ring 211 having a longitudinal hole. The mesh bottom cap 22 includes an annular member 221 defining a through-hole 222. A ledge 223 extends radially inward from an inner periphery of the through-hole 222 along a bottom side of the annular member 221 facing away from the ring 211. The lower mesh 23 abuts the ledge 223. The inner periphery of the annular member 221 is in tight coupling with the outer periphery of the ring 211 through material resiliency.

In the illustrated embodiment, the mesh top cap 24 includes an annular member 241 defining a through-hole 242. A ledge 243 extends radially inward from an inner periphery of the through-hole 242 along a top side of the annular member 241 facing away from the ring 211. The upper mesh 25 abuts the ledge 243. The inner periphery of the annular member 241 is in tight coupling with the outer periphery of the ring 211 through material resiliency.

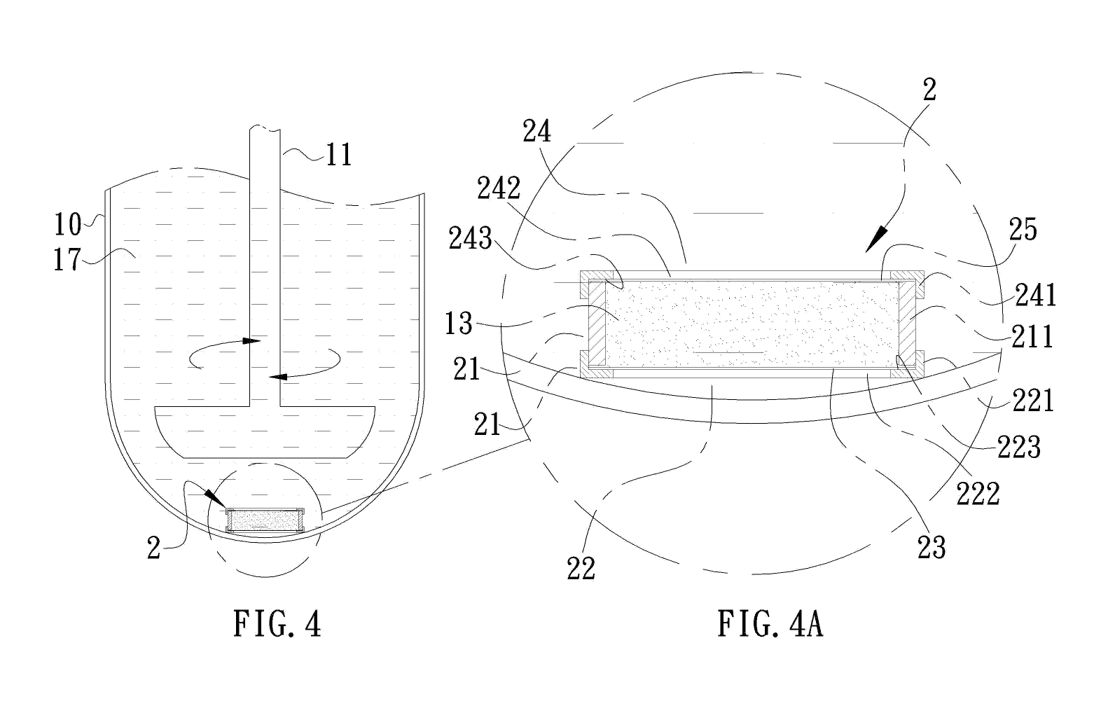

With reference to FIG. 4, when using the container 2 according to the present invention to carry out an in vitro dissolution rate test of efficient components of a pharmaceutical topical patch 13, a reagent 17 simulating human body tissue is filled into a vessel 10 and stirred by a paddle 11 to stimulate dissolution of the efficient components in the human body tissue. The pharmaceutical topical patch 13 to be tested is placed in the container 2. Due to provision of the mesh bottom cap 22 mounted to the bottom of the body 21, the pharmaceutical topical patch 13 can be in sufficient contact with the reagent 17. Furthermore, due to provision of the mesh top cap 24 on top of the body 21, the pharmaceutical topical patch 13 is retrained inside the body 21 without the risk of excessive expansion due to excessive absorption of the reagent 17, avoiding interference with stirring of the paddle 11.

To effectively retain the pharmaceutical topical patch 13, the pharmaceutical topical patch 13 is mounted on top of the lower mesh 23, which, in turn, is mounted on top of the ledge 223. A bottom face of the ring 211 presses against and, thus, retain the pharmaceutical topical patch 13 after the ring 211 is inserted into the annular member 221 with the outer periphery of the ring 211 in tight coupling with the inner periphery of the annular member 221, further enhancing the retaining effect of the pharmaceutical topical patch 13 while allowing easy detachment and replacement of the lower mesh 23.

Furthermore, due to provision of the mesh top cap 24 including the annular member 241 defining the through-hole 242 with a ledge 243 extending radially inward from the inner periphery of the through-hole 242 along the top side of the annular member 241 facing away from the ring 211, with the upper mesh 25 abutting the ledge 243, and with the inner periphery of the annular member 241 in tight coupling with the outer periphery of the ring 211 through material resiliency, easy detachment and replacement of the upper mesh 25 are allowed.

Although specific embodiments have been illustrated and described, numerous modifications and variations are still possible without departing from the essence of the invention. The scope of the invention is limited by the accompanying claims.

1. A container for an in vitro dissolution rate test of efficient components of a pharmaceutical topical patch comprising:
a body having an open upper end, with a mesh bottom cap mounted to a bottom of the body, with the mesh bottom cap including a lower mesh; and
a mesh top cap having an upper mesh, with the upper mesh covering the upper end of the body.

2. The container for an in vitro dissolution rate test of efficient components of a pharmaceutical topical patch as claimed in claim 1, with the body including a ring having a longitudinal hole, with the mesh bottom cap including an annular member defining a through-hole, with a ledge extending radially inward from an inner periphery of the through-hole along a bottom side of the annular member facing away from the ring, with the lower mesh abutting the ledge, with an inner periphery of the annular member being in tight coupling with an outer periphery of the ring through material resiliency.

3. The container for an in vitro dissolution rate test of efficient components of a pharmaceutical topical patch as claimed in claim 1, with the mesh top cap including an annular member defining a through-hole, with a ledge extending radially inward from an inner periphery of the through-hole along a top side of the annular member facing away from the ring, with the upper mesh abutting the ledge, with an inner periphery of the annular member being in tight coupling with an outer periphery of the ring through material resiliency.
